(19) United States
(12) Patent Application Publication
(10) Pub. No.: US 2016/0036482 A1
(43) Pub. Date: Feb. 4, 2016

(54) APPARATUS AND METHOD FOR ANTENNA TUNING

(71) Applicant: GOOGLE TECHNOLOGY HOLDINGS LLC, MOUNTAIN VIEW, CA (US)

(72) Inventors: Gregory R. Black, Vernon Hills, IL (US); Armin W. Klomsdorf, Chicago, IL (US); John R. Mura, Oakbrook Terrace, IL (US); Dale Schwent, Schaumburg, IL (US)

(21) Appl. No.: 14/445,715

(22) Filed: Jul. 29, 2014

(51) Int. Cl. H04B 1/40

(52) U.S. Cl. CPC H04B 1/40

(57) ABSTRACT

A method (300, 400, 500) and apparatus (100) provide for antenna tuning by determining (305, 405) a tuning selection input that occurs in conjunction with a wireless communication session; and determining (310, 410), based on the tuning selection input, a setting of an antenna matching network, wherein the setting maximizes power transfer from a transmitter power amplifier (PA) to an antenna subject to a constraint that a return loss does not degrade past a threshold.

### FIELD OF THE INVENTION

The present invention relates generally to wireless communication devices, and more specifically to optimizing antenna tuning for a wireless communication device.

### BACKGROUND

Wireless communication devices, and in particular handheld wireless communication devices, have at least one antenna used for communications. The antenna may be used to radiate a transmit signal many times during a communication session. The transmit signal radiated from the antenna is affected by many variables, such as the position of the fingers and hand of a user holding the wireless communication device, the position of the wireless communication device with reference to other parts of the user's body, such as the head, the operational frequency of a transmitter coupled to the antenna, and the modulation used for the wireless signal being transmitted by the antenna. The antenna may be coupled to a power amplifier output of the wireless communication device by an antenna matching network, which may be adjusted by selections of values at inputs to the antenna matching network that are determined in an attempt to optimize the signal that is radiated from the antenna. One technique for optimization is to choose a setting for the antenna matching network that optimizes the power radiated by the antenna.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments. The description is meant to be taken in conjunction with the accompanying drawings in which:

FIG. 1 is a functional block diagram of a wireless communication device, in accordance with certain embodiments.

FIG. 2 is a table of maximum return loss values for various bands of a cellular network required in order to meet a performance specification, in accordance with certain embodiments.

FIG. 3 is a flow chart of some steps used in a method for antenna tuning, in accordance with certain embodiments associated with a design phase of a wireless communication device.

FIG. 4 is a flow chart of some steps used in a method for antenna tuning, in accordance with certain embodiments associated with deployed wireless communication devices.

FIG. 5 is a flow chart of some additional steps used in the method described with reference to FIG. 4, in accordance with certain embodiments associated with deployed wireless communication devices.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the embodiments.

### DETAILED DESCRIPTION

In the description below, like reference numerals are used to describe the same, similar or corresponding parts in the several views of the drawings.

Embodiments described herein generally relate to determining a setting for an antenna matching network that optimizes a wireless communication signal radiated by an antenna that is coupled to the matching network, using a unique technique that uses both power maximization and return loss to achieve an optimized signal.

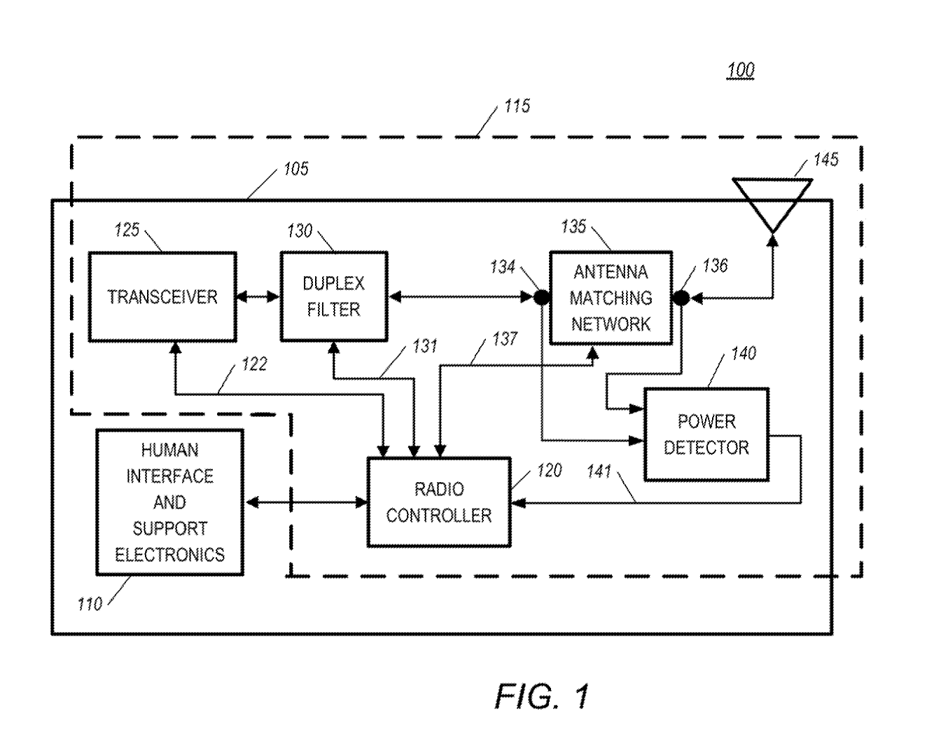

Referring to FIG. 1, an electronic block diagram shows a wireless communication device 100, in accordance with certain embodiments. The wireless communication device 100 comprises a housing 105 that contains electronic functions and networks. A human interface and support electronics function 110 performs such functions of the wireless communication device as display control, control button sensing, position sensing, battery control, audio input and output, and may comprise one or more radio functions (not shown in FIG. 1). The human interface and support electronics function 110 comprises at least one processor (not shown in FIG. 1). A radio function 115 is coupled to the human interface and support electronics function 110. The radio function 115 comprises a radio controller 120 that is coupled to a transceiver 125, a duplex filter 130, an antenna matching network 135, a power detector 140, and an antenna 145. The manner in which the antenna 145 is drawn is intended to indicate that it may comprise one or more antenna elements that may be situated outside of the housing 105, or on the housing 105, or within the housing 105. The transceiver 125 has a radio frequency (RF) power amplifier (PA) output port that is coupled to an RF input port of the duplex filter 130. The duplex filter 130 has an RF output port that is coupled to an RF input port of the antenna matching network 135 through an RF coupler 134, the antenna matching network 135 has an RF output port that is coupled through an RF coupler 136 to an RF input port of the antenna 145. The RF ports described above may be bidirectional input/output ports. The radio function 115 has a power detector 140 which is coupled to the RF couplers 134, 136, from each of which up to two signals may be received by the power detector 140: one that indicates the magnitude of the forward power and the other that indicates the magnitude of the reflected power. In an embodiment RF couplers 134, 136 are directional couplers used for measuring signal magnitude into and out of the input antenna matching network 136 and into and out of the antenna 145. In another embodiment RF couplers 134, 136 are high impedance probes used for detecting the signal voltages at the antenna matching network 135 input and the antenna 145 input. The power detector 140 converts at least some of these signals to magnitude values and the values are coupled to the radio controller 120 by signal 141.

The radio controller 120 may comprise a processing system or be a portion of the processing system of the human interface and support electronics function 110. The radio function 115 may be a wide area radio function, a Bluetooth radio function, or a local area network function, a satellite radio function, or any other radio function that is susceptible to antenna impedance changes due to the use and environment of the wireless communication device. The radio function 115 may provide transmitting and receiving functions (e.g., a cellular system transmitter-receiver), or a transmitting only function (e.g., a sign-post transmitter). The wireless communication device 100 may be a cellular telephone, an electronic tablet, an electronic pad, a local area network device, a vehicular communication device, or other radio device that is used in a way that causes changes to the antenna impedance of the antenna. The transceiver 125, the duplex filter 130, the antenna matching network 135, the power detector 140, and the antenna 145 may be conventional devices. The radio controller 120 may be a conventional device having unique program instructions, and is coupled to the transceiver 125 by signals 122 which control the parameters of the transceiver such as operational frequency, maximum power output, and modulation.

The RF PA of the transceiver 125 is designed to generate an RF signal at a selected power when coupled to a designed output impedance of the RF transmitter, e.g., 50 ohms resistive. The RF signal is coupled through the duplex filter 130, the antenna matching network 135, and the power detector 140 to the antenna 145. The duplex filter 130 provides isolation between the RF energy of signals intercepted by the antenna 145 that are within a receiving bandwidth and the RF energy generated by the transceiver 125 that is within a transmitting bandwidth. The duplex filter 130 may be a device that can be switched to accommodate different transmit and receive operating frequencies used in different radio networks or within a radio network at differing times. The setting of the duplex filter 130 to accommodate different transmit and receive operating frequencies is coupled from the radio controller 120 by signal 131. The antenna matching network 135 is a circuit that provides a selected impedance transform, also termed a setting, which is selected by control signals 137 from the radio controller 120. The antenna matching network 135 may comprise stages of passive impedance devices, each stage able to be set to one of a plurality of gains and/or phases that are primarily within a narrow frequency band. The narrow frequency bands of the stages are combined to provide an impedance transform over a wider frequency band. The selection may involve the use of transistor switches. Other types of circuits for providing a set of impedance transforms in an antenna matching network 135 may alternatively be used.

The controls signals 137 may convey a tuning selection input, which represents a particular set of environmental conditions that are converted by a tuning table (not shown in FIG. 1) within the antenna matching network 135 to a setting of the antenna matching network 135. Additionally, the control signals may set or alter specific values of a setting of the antenna matching network 135. In some embodiments, the tuning table may be within the radio controller 120 instead of the antenna matching network 135 and the control signals 137 may then comprise the antenna matching network setting values (also referred to as setting values or settings). In these embodiments, if and when alterations to setting values are made from values determined by a tuning selection input, the alterations are determined within the radio controller 120 and the new setting values are conveyed by the control signals 137. A setting of the antenna matching network 135 is used to compensate for a particular antenna impedance, intervening circuits, and other conditions. In an embodiment the power detector 140 may be considered to comprise RF directional couplers 134,136 having forward and reverse power sensing. In this way a power detector 140 can detect return loss magnitude which is a function of forward and reverse signals at the input of the antenna matching network 135, and power detector 140 can detect the power delivered to the antenna which is a function of forward and reverse signals at the input of the antenna 145. In another embodiment the power detector 140 may be considered to comprise high impedance probes 134,136. In this way a power detector 140 can detect the antenna matching circuit return loss magnitude and the power delivered to the antenna, both of which are a functions of the signal voltage at the input of the antenna matching network 135, the signal voltage at the input of the antenna 145 and the impedance of the antenna 145, which can be a predetermined or a measured impedance. The power detector 140 may comprise RMS (root mean square) voltage detectors, envelope detectors, or measurement receivers. Forward PA power is the power coupled from the RF PA of the transceiver 125 to the antenna matching network 135; reverse matching network power is the power reflected back from the antenna matching network 135 to the RF PA output of the transceiver 125. Forward matching network power is the power coupled from the antenna matching network 135 to the antenna 145. Reverse antenna power is the power reflected from the antenna 145 to the matching network 135. Power may also be reflected by other couplings between the RF PA of the transceiver and the antenna 145, such as the coupling to the transmit filter portion of the duplex filter 130, and the couplings of the RF couplers 134, 136. However, for the combinations of antenna matching network settings and conditions used in the wireless communication device 100, the power reflected for all other couplings is small compared to the power reflected back from the coupling at the antenna matching network 135. The antenna 145 has an input impedance that varies depending upon environmental conditions and factory build tolerances.

A method used in certain embodiments to select a setting for the antenna matching network 135 is to determine a setting output that maximizes radiated antenna power for a given input power (i.e., maximizing power efficiency) at the beginning of a communication session, and maintain the setting while the operational frequency, modulation, and other environmental conditions are not changed. The radiated antenna power can be maximized by maximizing the power delivered to the antenna 145, which is the forward matching network power from the antenna matching network 135 to the antenna 145 minus the reflected antenna power from the antenna 145 to the antenna matching network 135. The maximum power delivered to the antenna 145 can be achieved by maximizing the scalar gain, /G/=/S₂₁/, of the antenna matching network 135, the delivered power in dB units being 20*Log₁₀/S₂₁/, where S₂₁ is the s-parameter defining the forward voltage gain with the output port impedance set to the antenna impedance. Thus the power detector 140 can be employed to measure the power delivered to the antenna 145 by measuring the scalar gain of the antenna matching network. Power detector 140 can also be used to measure the return loss of the antenna matching network 135 by measuring the scalar reflection coefficient, /S₁₁/, of the antenna matching network 135, the return loss in dB units being equal to −20*Log₁₀/S₁₁/, where S₁₁ is the s-parameter defining the voltage reflection coefficient at the input port of antenna matching network 135. In an embodiment power detector 140 measures the parameters or signal levels that are used by the radio controller 120 to determine the scalar gain and the and reflection coefficient of the matching network 135. In another embodiment power detector 140 includes programmable functionality for determining the scalar gain and reflection coefficient. The operational frequency is the spectrum resource that is allocated at the beginning of a communication session to convey payload information (voice, video, data files, etc.). For example, in some cellular systems, it is termed a band. However, recent investigations of combinations of wireless communication devices and environmental conditions have shown that setting the antenna matching network 135 to achieve maximum power efficiency can generate signal distortion that prevents the wireless communication device 100 from meeting certain newer performance specifications that have been established for certain radio systems. The investigations have shown that when the power efficiency is maximized subject to a constraint on return loss, the performance specifications can be met, whereas when power efficiency is maximized without constraining the return loss the performance specification are not always met. For example when return loss exceeds a threshold, error vector magnitude (EVM) and adjacent channel leakage ratio (ACLR) specifications can fail to be met. The constraint on return loss depends substantially upon the operational frequency, the modulation, the transmit portion of the duplex filter, and the antenna design. Since the antenna design does not change, the constraint may be determined using the operational frequency, the modulation, and the duplex filter. As noted above, the duplex filter may be determined solely by the operational frequency and modulation, reducing the constraint to be determined using the operational frequency and modulation.

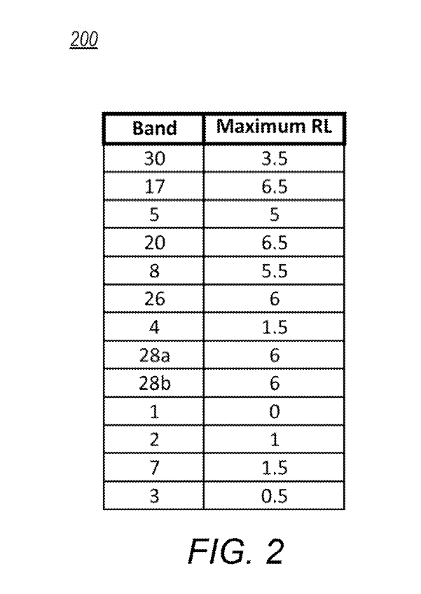

Referring to FIG. 2, a table 200 shows estimated maximum return loss (RL) values determined by simulation and measurement for certain operational frequencies, in accordance with certain embodiments. The operational frequencies are certain bands that are defined for Long Term Evolution (LTE) cellular systems specified by the 3^{rd} Generation Partnership Project (3GPP™) LTE standard, release 8. The maximum return losses were those determined for 50 RB E-UTRA modulation (as specified for LTE) in order to pass an Adjacent Channel Leakage power Ratio (ACLR) test specified in the 3GPP specification for LTE as ACLR1. An estimated filter group delay of the duplex filter 130 and other components is associated with each band. In this document return loss is defined as the negative of the decibel value of the ratio of the reflected power to the forward power at the power detector 140. Hence a higher return loss relates to a higher reflected power for a given forward power. Maximum return losses can be empirically determined for other radio system types in a similar manner. Methods are described below that may permit the wireless communication device to meet these performance specifications.

The methods described below rely on the use of a tuning selection input within a wireless communication device 100 to determine a setting for the antenna matching network 135. A tuning selection input may be used to obtain an initial setting of an antenna matching network that can then be optimized efficiently to provide a maximum transmitted power for the wireless control device, subject to the constraint of a maximum return loss. This results in improved performance. The tuning selection input may include information of any the following types: operational frequency identification, modulation type identification, call type (voice v. data), a speakerphone activation state, a speaker activation state, a wireless local area network activation state, a user identity, grip information, body proximity information, sensor input information, a transmit power level, a transmit receive level, and a receive signal to noise ratio. Modulation type may comprise a modulation method (18QAM, QPSK, SC-FDMA, etc.) and symbol or chip rate, and other related parameters. For example, a quantity of resource blocks that are in a frame may serve to convey the modulation information. In certain embodiments, selected ones of these information types, which are available within the wireless communication device, may be used during a design phase of a particular model of a wireless communication device to create a tuning table that establishes a best estimated setting for an antenna matching network that is to be used in the particular model of wireless communication devices for various combinations of the selected information types. Each combination of the selected information type is a tuning selection input. In the design phase, the effect of the environment on the antenna impedance is estimated for a nominal set of components used in the model of the wireless communication device, for a plurality of tuning selection inputs. This is converted to a tuning table that is stored in the wireless communication device. There are several embodiments that combine the use of a table with the technique of maximizing the forward power under the constraint of a maximum return loss.

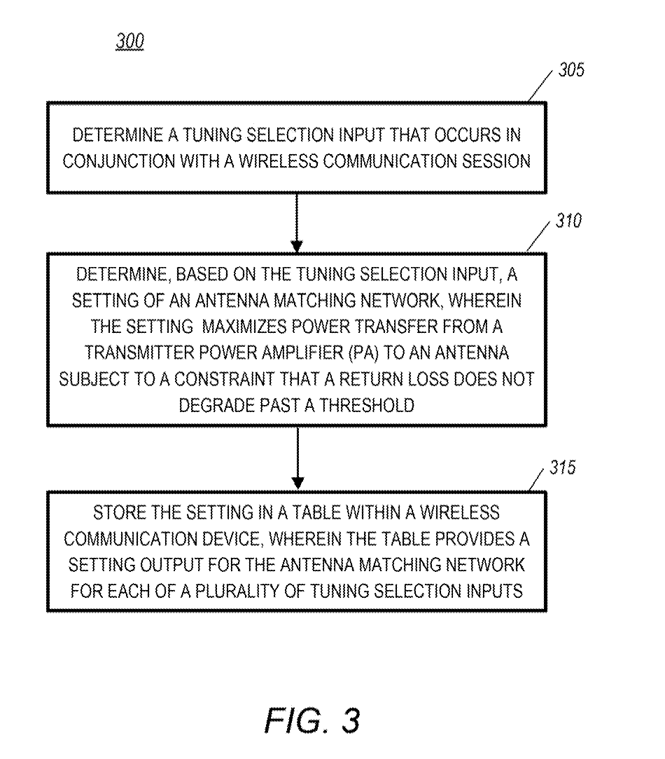

Referring to FIG. 3, a flow chart 300 shows some steps of a method used to tune an antenna of a wireless communication device, in accordance with certain embodiments. These embodiments may be used in a product design phase, in which empirical techniques including simulation and lab measurements are used to model the performance of a certain model of a wireless communication device 100 under a variety of environment conditions. Analytical techniques may also be used, either in addition to empirical techniques or substituting for some of the empirical techniques. For each environmental condition the setting for the antenna matching network 135 may be experimentally iterated to determine a best setting. The best settings for the environments then form a tuning table of settings of the antenna matching network 135. The tuning table can then be stored in wireless communication devices of that model and used to determine a best setting of the antenna matching network 135 for an environment. Each environmental condition is conveyed to the tuning table as a tuning selection input, which comprises information available within the wireless communication device, some examples of which were described above. For these embodiments, a tuning selection input is determined at step 305 of FIG. 3, wherein the tuning selection input is one that occurs in conjunction with a wireless communication session of the wireless communication device 100. The information in each tuning selection input may be limited by memory resources of the wireless communication device and availability of the information within the wireless communication device. As an example of memory resource limitations, if the tuning table is to generate a setting output for an antenna matching network that has gain and phase values for 8 frequency sub-bands of the antenna matching network, and the information available as possible inputs to the wireless communication device 100 comprises 12 operational frequencies, 30 modulation types, binary inputs to sense grip, call type (voice v. data), a speakerphone activation state, a speaker activation state, a wireless local area network activation state, and indications of 32 transmit power levels, 32 transmit receive levels, and 32 receive signal to noise ratios. It will be appreciated that the amount of data that would be needed for every combination is very large. Accordingly, tuning selection inputs are chosen from the combination of all possible inputs to provide tuning selection inputs that span the ranges of information types while meeting a maximum memory limit. This results in quantization of the tuning selection inputs having quantization differences that may exceed the resolution of the information.

At step 310 of FIG. 3, a determination of an antenna matching network setting is made based on the tuning selection input. This may be done empirically by emulating the environmental conditions for a sample of the model of the wireless communication device 100 for which a tuning table is being determined. For example, the sample wireless communication device 100 may be positioned with reference to a human head mannequin based on tuning selection inputs such as call type (voice v. data), a speakerphone activation state, and a speaker activation state. As another example, a duplex filter of the wireless communication device 100 is selected based on the operational frequency, and transceiver 125 signals are generated using the operational frequency and modulation. In some embodiments, the determination of the setting is made based on achieving maximum radiated output power subject to the constraint that the return loss does not degrade past a threshold. In other words, the determination is subject to a constraint of a maximum return loss threshold. In some embodiments, the determination of the setting is made based on achieving maximum radiated output power, without a constraint on return loss. These embodiments may be models of wireless communication devices for which the optimization will be done within the wireless communication device. For other embodiments, it may be that the design of the wireless communication device includes a tuning table that was determined without the constraint on return loss and the optimization can be accommodated by a software upgrade. For other embodiments, it may be deemed that it is better to perform the optimization in the wireless communication device because the settings determined for the tuning table during the design phase, whether they included using the return loss constraint or not, can be improved. This may be due to the variation of parts values due to parts' tolerances between wireless communication devices of the same model (e.g., filter delays and antenna difference) and/or the quantization of the settings in the tuning table caused by memory limitations. At step 315 of FIG. 3, the antenna marching network settings are stored in a tuning table within a wireless communication device 100. The table provides a setting output for the antenna matching network 135 for each one of a plurality of tuning selection inputs.

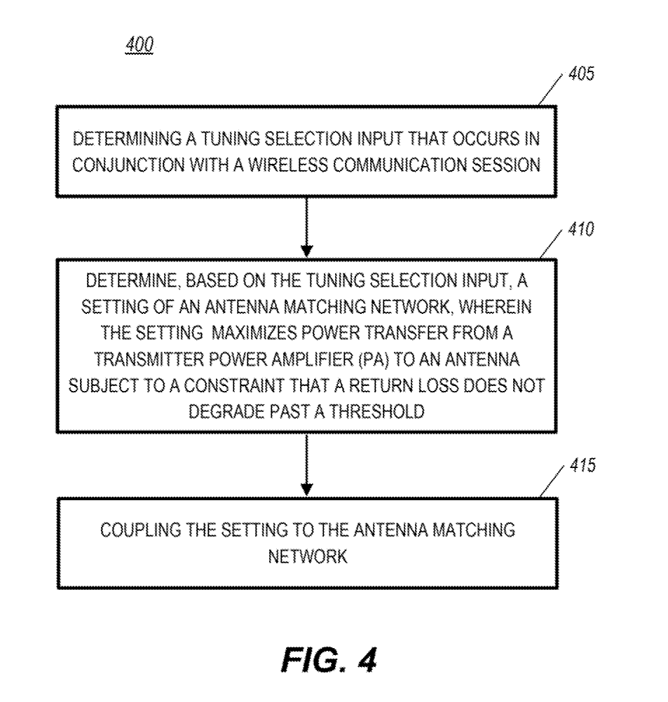

Referring to FIG. 4, a flow chart 400 shows some steps of a method used to tune an antenna of a wireless communication device, in accordance with certain embodiments. This method may be associated with deployed wireless communication devices. At step 405, a tuning selection input is determined. The tuning selection input is determined from information generated within the wireless communication device and is determined in conjunction with a wireless communication session of the wireless communication device 100. The tuning selection input is coupled to a tuning table of the wireless communication device 100. In some embodiments, the information includes values that exist at the beginning of the communication session and the tuning selection input is not changed during the session. In other embodiments, a change of certain of the values may cause a new tuning selection input during the session that includes the changed values. At step 410, a determination of an antenna matching network setting is made based on the tuning selection input. The setting from the tuning table is coupled at step 415 to the antenna matching network 135. In some embodiments, the setting is coupled to the antenna matching network 135 without substantial modification to the setting. In these embodiments, the settings in the tuning table have been determined using a technique of determining, during the design stage, the settings so as to achieve maximum power transfer to the antenna under the constraint of a maxim return loss. In these embodiments, a determination may be made during the design phase that parts tolerances and quantization of the input settings are small enough to warrant using tuning table settings for the antenna matching network 135 without modification.

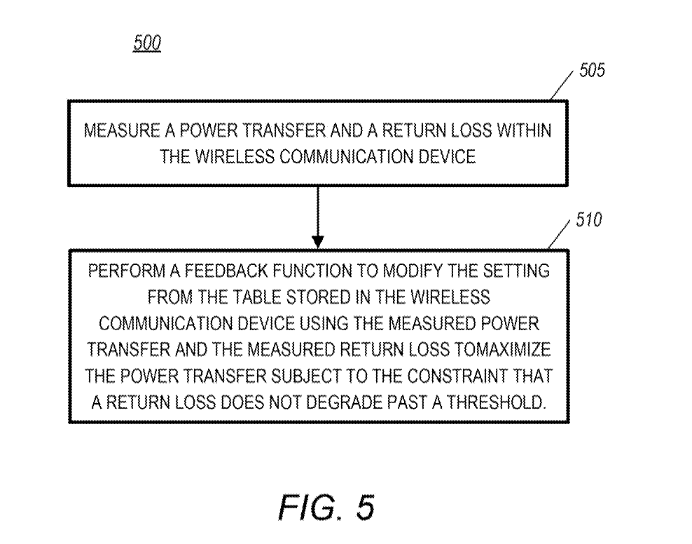

Referring to FIG. 5, a flow chart 500 shows some steps of a method used to tune an antenna of a wireless communication device, in accordance with certain embodiments. These steps describe some embodiments that include the steps described above with reference to FIG. 4, but in which additional steps 505, 510 are added between steps 410 and 415. At step 505, a power transfer and a return loss are measured by the power detector 140. The power transfer is the power transferred from the transceiver 125 to the antenna 145. At step 510, a feedback function is performed to modify the setting obtained in step 410 from the tuning table stored in the wireless communication device, using the measured power transfer and the measured return loss to maximize the power transfer subject to the constraint that a return loss does not degrade past a threshold. “Degrade past a threshold” means exceeding a maximum return loss.

It should be apparent to those of ordinary skill in the art that for the methods described herein other steps may be added or existing steps may be removed, modified or rearranged without departing from the scope of the methods. Also, the methods are described with respect to the apparatuses described herein by way of example and not limitation, and the methods may be used in other systems.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “coupled” as used herein is defined as connected, although not necessarily directly and not necessarily mechanically.

Reference throughout this document are made to “one embodiment”, “certain embodiments”, “an embodiment” or similar terms The appearances of such phrases or in various places throughout this specification are not necessarily all referring to the same embodiment. Furthermore, the particular features, structures, or characteristics attributed to any of the embodiments referred to herein may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference may be made in this document to actions that are related to signals (that is, electrical values such as serial or parallel voltage or current values that are described with or without using the word “signal”). These actions are variously described as “coupling”, “receiving”, “transmitting”, “using”, “transferring” “generating”, “returning”, “conveying” and the like, in various verb forms. These actions are often described in a form in which the signal performs the action or the action acts upon the signal between two entities or functions. For example, “Signal X is coupled from function A to function B”, or “entity A transfers signal X to function B”. Often times one or the other or both of the entities or functions are not explicitly stated. For example, “Signal X is returned from entity A”. In these cases one or both of the entities or functions are often clearly implied by the context. It will be appreciated that the actions may include the storage and retrieval of the signal in a memory that is an entity in addition to the two entities or functions, or a memory that is part of one or the other of the entities or functions, and that the use of the memory may add a delay in the action described. (Such delays would have a duration that is appropriate for the embodiment being described.) Accordingly, the actions described for signals that occur between two entities or functions may imply storage in memory as part of the action. This is particularly true when the entities or functions are embodied within the same device. (In some instances one of the entities or functions that is related to the action may be explicitly stated to be, or may be implied to be, a memory.) As a consequence, the actions described above may be interpreted in many instances as meaning “storing” or “retrieving” the signal in/from a memory, or as including “storing” or “retrieving” the signal in/from a memory as a first part of the action. Just one example of this includes “transmitting a signal”, which may be interpreted in some embodiments to mean “storing a signal and transmitting the stored signal”, wherein the signal is to be later transmitted to an entity or function that may not be explicitly named.

The processes illustrated in this document, for example (but not limited to) the method steps described in FIGS. 3-5, may be performed using programmed instructions contained on a computer readable medium which may be read by processor of a CPU. A computer readable medium may be any tangible medium capable of storing instructions to be performed by a microprocessor. The medium may be one of or include one or more of a CD disc, DVD disc, magnetic or optical disc, tape, and semiconductor based removable or non-removable memory. The programming instructions may also be carried in the intangible form of packetized or non-packetized wireline or wireless transmission signals..

In the foregoing specification, specific embodiments have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method comprising the steps of:
determining a tuning selection input that occurs in conjunction with a wireless communication session; and
determining, based on the tuning selection input, a setting of an antenna matching network, wherein the setting maximizes power transfer from a transmitter power amplifier (PA) to an antenna subject to a constraint that a return loss does not degrade past a threshold.

2. The method according to claim 1, wherein the tuning selection input includes one or more types of information selected from a group of information types that includes an operational frequency, a modulation, a call type, a speakerphone activation state, a speaker activation indicator, a wireless local area network indicator, a user identity, grip information, body proximity information, a sensor input, a transmit level, a receive level, and a signal-to-noise ratio.

3. The method according to claim 1, wherein the step of determining the setting is performed using empirical techniques and the method further comprises:
storing the setting in a tuning table within a wireless communication device, wherein the tuning table provides a setting output for the antenna matching network for each of a plurality of tuning selection inputs.

4. The method according to claim 1, further comprising:
determining a setting of the antenna matching network from a tuning table stored in a wireless communication device, wherein the setting is based upon the tuning selection input, and wherein the tuning selection input is generated within the wireless communication device; and
coupling the setting to the matching network.

5. The method according to claim 4, further comprising:
measuring a power transfer and a return loss within the wireless communication device; and
performing a feedback function to modify the setting using the measured power transfer and the measured return loss to maximize the power transfer subject to the constraint that a return loss does not degrade past a threshold.

6. The method according to claim 5, wherein the feedback function employs the measured return loss to improve return loss when the return loss degrades beyond a threshold.

7. An apparatus, comprising:
a radio frequency (RF) power amplifier (PA);
an antenna;
a power detector coupled between the RF PA and the antenna;
an antenna matching network coupled to the antenna;
a tuning table; and
a controller coupled to the power detector and the antenna matching network, wherein the controller
determines a tuning selection input generated by the apparatus in conjunction with a wireless communication session that is supported by the apparatus,
determines from the tuning selection input a setting for the antenna matching network,
couples the setting to the antenna matching network,
determines a power transfer from the RF PA to the antenna and a return loss for power supplied to the antenna based on signals from the power detector,
determines a modified setting, wherein the modified setting maximizes the power transfer subject to a constraint that the return loss does not degrade past a threshold, and
couples the modified setting to the matching network.

8. The apparatus according to claim 7, wherein the tuning selection input includes one or more types of information selected from a group of information types that includes an operational frequency, a modulation, a call type, a speakerphone activation indicator, a speaker activation indicator, a wireless local area network indicator, a user identity, grip information, body proximity information, a sensor input, a transmit level, a receive level, and a signal-to-noise ratio.

9. The apparatus according to claim 7, wherein the power detector comprises two RF directional couplers, and wherein one RF directional coupler is coupled to the RF input of the antenna matching network and the other RF directional coupler is coupled to the RF output of the antenna matching network.

10. The apparatus according to claim 7, wherein the power detector comprises two high impedance probes, wherein one high impedance probe is coupled to the RF input of the antenna matching network and the other high impedance probe is coupled to the RF output of the antenna matching network.

11. An apparatus, comprising:
a radio frequency (RF) power amplifier (PA);
an antenna;
an antenna matching network coupled to the antenna
a tuning table that provides, based on tuning selection inputs, a setting for the antenna matching network of the apparatus, wherein the setting maximizes the power transfer subject to a constraint that the return loss does not degrade past a threshold, and
a controller coupled to the antenna matching network, wherein the controller
determines a tuning selection input generated by the apparatus in conjunction with a wireless communication session that is supported by the apparatus,
determines from the tuning table and the tuning selection input a setting for the tuning table, and
couples the setting to the matching network.

12. The apparatus according to claim 11, wherein the tuning selection input includes one or more types of information selected from a group of information types that includes an operational frequency, a modulation, a call type, a speakerphone activation indicator, a speaker activation indicator, a wireless local area network indicator, a user identity, grip information, body proximity information, a sensor input, a transmit level, a receive level, and a signal-to-noise ratio.

13. The apparatus according to claim 11, wherein the power detector comprises two RF directional couplers, and wherein one RF directional coupler is coupled to the RF input of the antenna matching network and the other RF directional coupler is coupled to the RF output of the antenna matching network.

14. The apparatus according to claim 11, wherein the power detector comprises two high impedance probes, and wherein one high impedance probe is coupled to the RF input of the antenna matching network and the other high impedance probe is coupled to the RF output of the antenna matching network.
